(19) United States
(12) Patent Application Publication
(10) Pub. No.: US 2014/0370724 A1
(43) Pub. Date: Dec. 18, 2014

(54) FLEXIBLE CIRCUIT CABLE WITH FLOATING CONTACT

(71) Applicants: Paul Kessler Rosenberg, Sunnyvale, CA (US); Michael Renne Ty Tan, Menlo Park, CA (US); Sagi Varghese Mathai, Berkeley, CA (US)

(72) Inventors: Paul Kessler Rosenberg, Sunnyvale, CA (US); Michael Renne Ty Tan, Menlo Park, CA (US); Sagi Varghese Mathai, Berkeley, CA (US)

(73) Assignee: Hewlett-Packard Development Company, L.P., Houston, TX (US)

(21) Appl. No.: 14/373,437

(22) PCT Filed: Apr. 18, 2012
(86) PCT No.: PCT/US2012/034121

§ 371 Date: Jul. 21, 2014

(51) Int. Cl. H01R 4/28; H01R 13/02; H01R 13/629

(52) U.S. Cl. CPC H01R 4/28; H01R 13/629; H01R 13/02
USPC 439/77

(57) ABSTRACT

An apparatus includes a flexible circuit cable to transport an electrical signal. The apparatus includes a mechanically floating contact integrated into the flexible circuit cable to facilitate connection of the electrical signal between a circuit and the flexible circuit cable.

### BACKGROUND

Flexible cable or flex cable is a flat structure having multiple signal connections. Such cable is often employed to connect multiple printed circuit boards that are often at peculiar distances or angles from one another. For instance, one end of a flex cable may be soldered into a first printed circuit board and the opposite end of the flex cable soldered into a second printed circuit board, wherein the flex cable routes signal connections between the respective printed circuit boards. Sometimes, the flex cable is soldered to a connector that is then connected to the printed circuit board. Connectors add expense and mechanical complexity to the flex cable.

### BRIEF DESCRIPTION OF THE DRAWINGS

FIG. 1 illustrates an example apparatus that utilizes a flexible circuit cable having a floating contact for a signal connection.

FIG. 2 is a schematic side view of the combination of a flexible circuit cable and floating contact of FIG. 1 as seen from a plane indicated by the line 2-2 in FIG. 1.

FIG. 3 illustrates an example of a flexible circuit cable having a circuit integrated on to the cable.

FIG. 4 illustrates an example of a flexible circuit cable that utilizes optoelectronic components for a circuit that is integrated on to the cable.

FIG. 5 illustrates a planar view of example contacts that are from a portion of a flexible cable.

FIG. 6 shows an example flexible circuit cable having a plurality of flexible contacts that are connected to an active circuit at the opposite end of the cable.

FIG. 7 shows an example of a flexible circuit cable that is integrated with a front housing and a rear housing.

FIG. 8 illustrates an example mounting of a flexible cable and circuit on to a printed circuit board.

FIG. 9 shows a close-up view of an example pressure pad applying contact pressure to a plurality of floating contacts associated with a flexible circuit cable.

FIG. 10 shows an application example of a plurality of flexible circuit cables that are configured as an array to support multiple optical connections on a printed circuit board arrangement.

### DETAILED DESCRIPTION

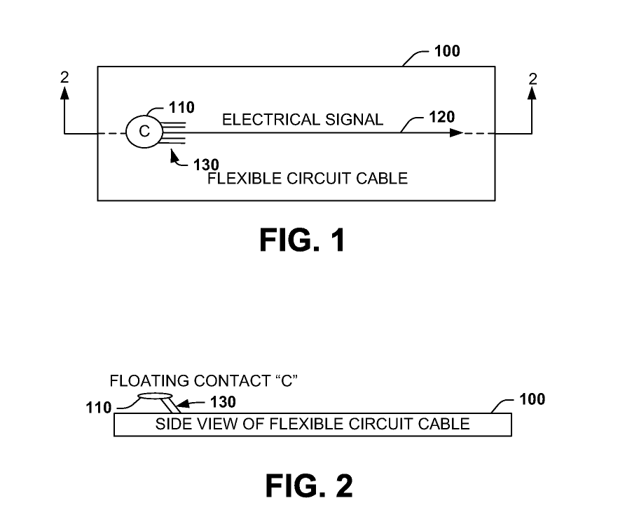

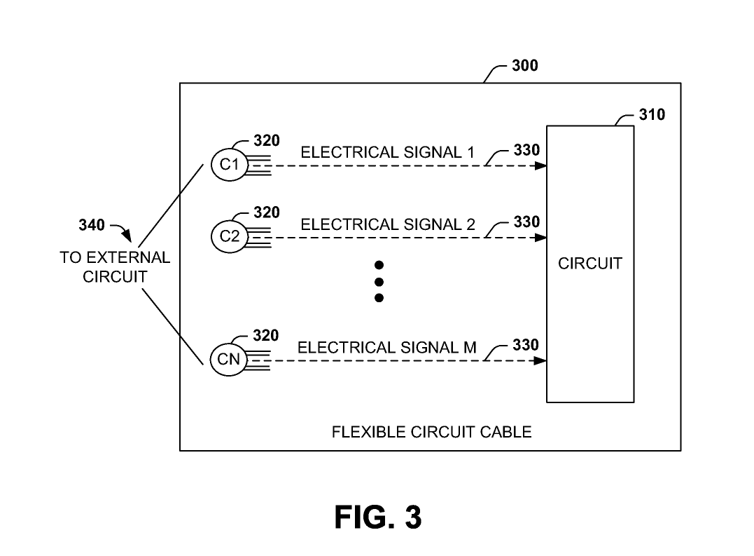

FIG. 1 illustrates an example apparatus that utilizes a flexible circuit cable 100 having a mechanical floating contact 110 for a signal connection. The flexible circuit cable 100 can transport an electrical signal 120 to circuits connected to the cable, wherein the circuits can include external circuits connected to the cable and active circuit elements that are integrated with the flexible circuit cable, for example. The floating contact 110 can be integrated into the flexible circuit cable 100 to facilitate connection of the electrical signal 120 between a circuit and the flexible circuit cable. The circuit can be connected to the flexible circuit cable 100 and include external electrical signal driver circuits, for example, that interact with active circuits on the flexible circuit cable as will be described below with respect to FIG. 3. The floating contact 110 can be attached to a peninsula structure 130 to enable flexing of the floating contact in an upward, downward, or sideways direction in relation to a plane of the flexible circuit cable 100.

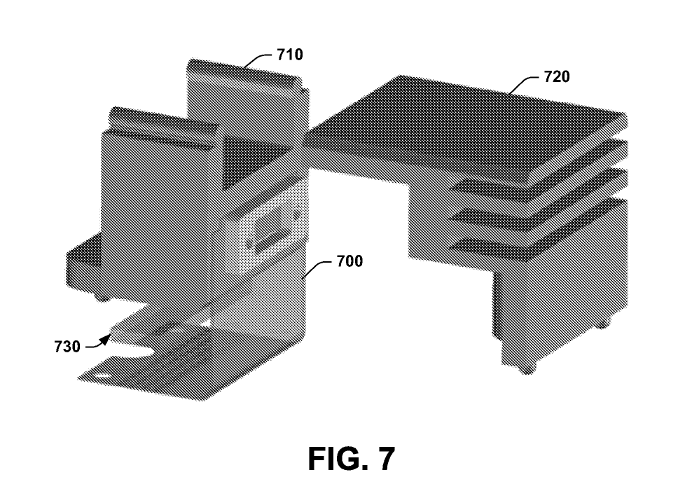

The floating contact can be attached to the peninsula structure 130 along a single edge, for example, across which the edge passes one or more electrical traces, (e.g., in a configuration similar to a pyramid) to enable flexing of the floating contact in an upward, downward, or sideways direction in relation to the flexible circuit cable 100. A pressure pad (shown in FIG. 7) can apply contact pressure to the floating contact 110. An adhesive layer can be fabricated on one or both contact surfaces of the pressure pad that is applied to a structure that places mechanical forces on the pressure pad, to hold it in a suitable position against the array, and for contact pressure to be applied to the floating contact 110. Components can apply a compressive force through the pressure pad and across the array of electrical contacts. This can include a screw or cantilever latch, for example, that is applied to a structure that places mechanical forces on the pressure pad and to enable the contact pressure to be applied to the floating contact 110. One or more alignment posts can be formed into a structure that frames or surrounds an array of floating contacts 110. The alignment posts should enable positioning with sufficient accuracy with respect to the contact array that the alignment posts can serve to align the contact array with respect to electrical contacts formed on a second structure, such as a PCB, comprising another mating array of electrical contacts.

FIG. 2 illustrates a side view of the combination of the flexible circuit cable 100 and floating contact 110 of FIG. 1 and seen from a plane indicated by the line 2-2 in FIG. 1. Although shown in a direction flexing upwards from the cable 100 in FIG. 2, the floating contact 110 could also be oriented to be flexing downwards from the plane of the cable to make connection with circuit elements outside the flexible circuit cable 100. Also, if the flexible circuit cable 100 were vertically oriented 90 degrees from the horizontal plane position shown, the floating contact 110 could be flexed in a sideways position—inwards or outwards from the vertically oriented plane of the cable. Although the floating contact 110 is illustrated as a circular structure for purposes of illustration, other shapes are possible for the floating contact such as square-like structures, rectangular structures, elliptical structures, triangular structures, trapezoidal structures, and so forth.

By integrating the floating contact 110 into the flexible circuit cable 100, connections can be made to external circuits without having to also integrate a connector on to the flexible circuit cable. Such connections can be made by pressure applied to the floating contact 110 that in turn is forced to contact with a mating circuit pad of an external circuit as will be described below. Since the floating contact 110 can move with respect to the flexible circuit cable 100 and apply a spring force, less mechanical forces can be applied when making circuit contacts with the flexible circuit cable. Flexing of the floating contact 110 allows less mating force than conventional cables require that employ non-flexible and raised connection points applied to secure contact with outside circuit elements. Since less force can be applied to facilitate contact with the floating contact 110, smaller circuit applications can be supported since bulky cable mounting hardware to apply sufficient contact pressure can be mitigated. For instance, adhesives and foam-like structures can be utilized to apply pressure on the floating contact 110 in lieu of bulky mating screws that apply pressure in conventional applications.

In one example, a pressure pad (illustrated below) having a foam-like material can be employed to apply contact pressure to the floating contact 110. In another example, an adhesive could be applied to a structure that places mechanical forces on the pressure pad and to enable the contact pressure to be applied to the floating contact 110. In another example, a screw or rivet, for example, could be applied to a structure that places mechanical forces on the pressure pad and to enable the contact pressure to be applied to the floating contact 110. The floating contact 110 can have a flat surface that provides an electrical connection when the peninsula structure 130 is flexed. The floating contact 110 could also be raised or dimpled to facilitate circuit contact when pressure is applied. The floating contact 110 can also wipe the surface of a contact pad to facilitate reliable electrical connection. As will be described below, an alignment post can be employed to align the floating contact 110 with a connection from a circuit to the flexible circuit cable 100.

An active circuit can be integrated on to the flexible cable 100 and connected to the floating contact 110 as will be shown and described below with respect to FIG. 3. In one example, the active circuit can be associated with an optoelectronic conversion circuit that is connected to the floating contact 110. The optoelectronic conversion circuit can include a laser diode to convert an electrical signal applied to the floating contact 110 to an optical signal output in the optoelectronic conversion circuit, for example. In another example, the optoelectronic conversion circuit could include a photodiode to convert an optical signal received at an input to the optoelectronic conversion circuit and is converted to an electrical signal 120. In yet another example, the optoelectronic conversion circuit can be configured as an array of optoelectronic conversion circuits on a printed circuit board.

Flexible printed circuits such as provided by the flexible circuit cable 100 offer many benefits in packaging of electronic devices and systems. For example, active and passive components can be attached to the flexible circuit cable 100 using solder and conductive adhesives. The flexible circuit cable 100 can also be deformed to fit the needs of the application and space available. In one application example, optoelectronic engines have been assembled on flex circuits. These devices have conventionally used a relatively large and costly electrical connector. Connectors offer benefits such as simplified rework, and the ability to attach or remove components very late in the printed circuit board assembly process. However, electrical connectors have the disadvantage of being expensive, degrading electrical performance, and consuming valuable space on the printed circuit board. The flexible circuit cable 100 mitigates the issues associated with electrical connectors. Since the connector contacts 110 are integrated with the flexible circuit cable 100, they do not degrade signal integrity, or add significantly to cost or size, for example.

FIG. 3 illustrates an example of a flexible circuit cable 300 having a circuit 310 integrated on to the cable. As shown, floating contacts 320 are denoted as C1, C2, and CN, where N represents a positive integer. Likewise, the floating contacts 320 are coupled to electrical signals 330 which are denoted as electrical signal 1, electrical signal 2, and electrical signal M, where M represents a positive integer. The electrical signals 330 are coupled to the circuit 310 which can include active and/or passive circuit elements. Such elements in the circuit 310 could be deposited on the flexible cable 300 via a deposition and etching process or can be soldered on to the cable, for example. The circuit 310 can include signal drivers, optoelectronic circuits, logic gates, transistors, memory elements, processors, analog components, digital analog converters, analog to digital converters, and so forth for example. As shown, the electrical signals 330 which are connected to the floating contacts 320 can be routed to an external circuit at 340 which would interface with the circuit 310.

The flexible circuit cable 300 can be formed with the floating electrical contact pads 320 on one side for the cable and the circuit 310 positioned on the other side of the cable, for example. The circuit could include active devices such as laser diodes for converting electrical signals 330 to light and/or photodiodes for converting light to the electrical signals 330, for example. The electrical signals 330 can be connected via metallic traces on the flexible circuit cable 300 to a second set of contact pads 320 at the other end of the cable. The contact pads 320 can be fabricated such that they are attached to floating leads, similar to the peninsular structure described above. The floating contacts 320 can be connected to the flexible circuit cable 300 along one short edge, for example, but the other three edges of the contact 320, or contact finger, are free to move. The floating contact 320 can be formed at the free end of the lead, for example.

In order to create the floating contact 320, a u-shaped cut feature can be formed surrounding the lead, for example. This can be achieved by removing a thin continuous line of flex material on the flexible circuit cable 300 and employing a process such as mechanical stamping or laser cutting, for example. During fabrication of the flexible circuit cable 300, the floating contact 320 can be built up utilizing a number of processes such as electroplating, solder reflow, or mechanical deformation, to produce a raised metal structure that makes suitable electrical contact to a second printed circuit board such as to the external circuit 340. Active devices such as laser arrays or photodiode (PD) arrays can be attached to the back surface of the flexible circuit cable 300 by solder reflow, vision aided pick and place, or a similar process, for example.

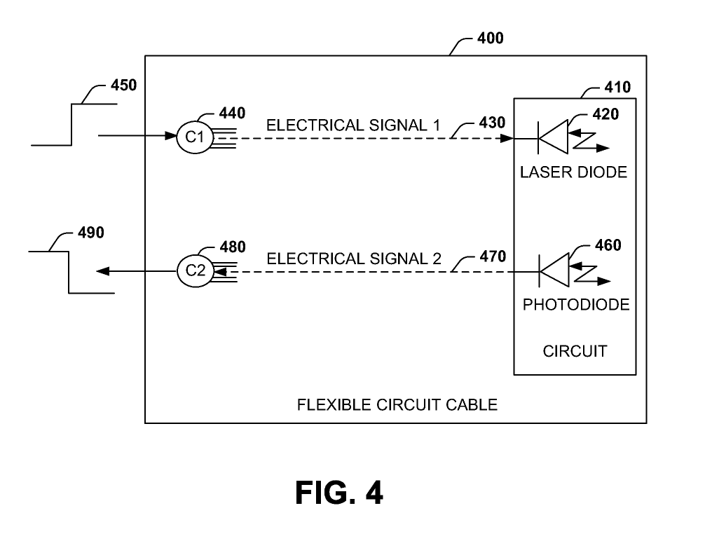

FIG. 4 illustrates an example of a flexible circuit cable 400 that utilizes optoelectronic components for a circuit 410 that is integrated on to the cable. The circuit 410 can include a laser diode 420 that converts an electrical signal 430 to a light output signal from the circuit 410. The electrical signal 430 can be driven though a floating contact 440 from an external circuit signal shown at 450. In another example, a photodiode 460 receives a light signal and converts to an electrical signal 470 that drives a floating contact 480 and provides a signal 490 to an external circuit. The combination of laser diode 420 and photodiode 460 components on the circuit 410 is sometimes referred to as an optoelectronic engine. Such components can be implemented as an array of photodiodes and/or laser diodes to support many signals in the flexible circuit cable 400. As noted previously, the circuit 410 can include substantially any type of circuit having active and/or passive circuit elements that can be of analog and/or digital in nature. For purposes of simplification of explanation, in the present example, various components of the circuit 410 are illustrated and described as performing different functions. However, one of ordinary skill in the art will understand and appreciate that the functions of the described components can be performed by different components, and the functionality of several components can be combined and executed on a single component.

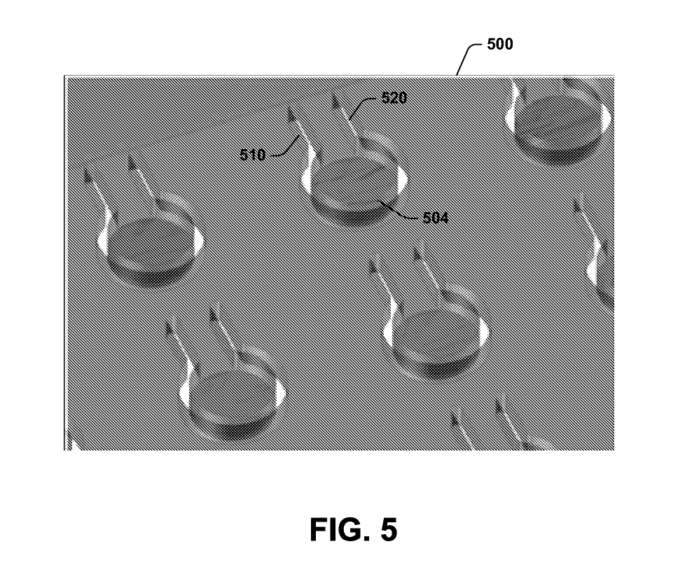

FIG. 5 illustrates a planar view of example contacts that are from a portion 500 of a flexible cable described above. One exemplary contact 504 is shown that is connected to leads 510 and 520, wherein the contact and leads form a flexible peninsula-like structure as previously described. Although a circular structure is shown for the example contact 504, other shapes are possible as previously described. Although the portion 500 shows a limited number of floating contacts, a large number of such contacts can be provided.

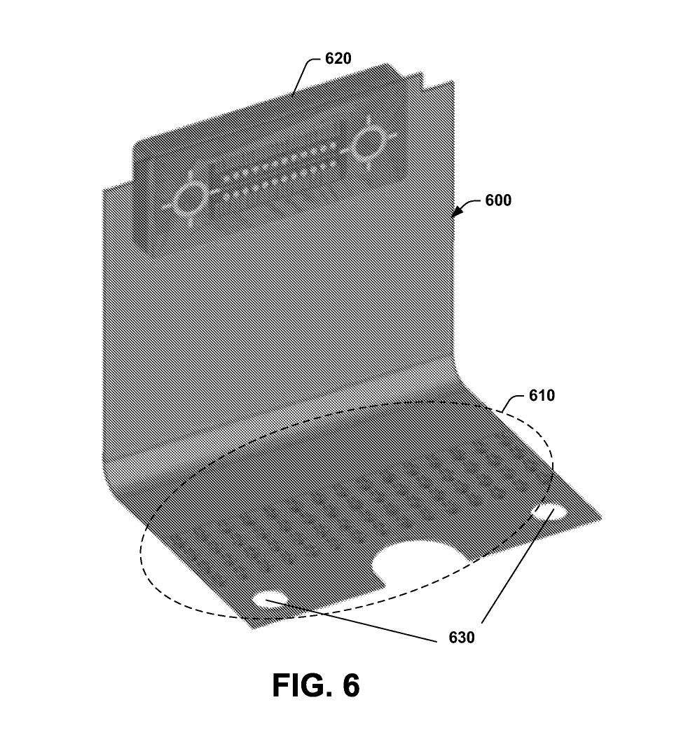

FIG. 6 shows an example flexible cable 600 having a plurality of flexible contacts 610 that are connected to an active circuit 620 at the opposite end of the cable. In this example, the active circuit 620 is an optoelectronic engine that employs laser diodes for outputting light from a driven electrical signal and employs photodiodes that convert received light to received electrical signals. As noted previously, the active circuit 620 can include substantially any type of electronic circuit having active and/or passive elements. As shown, the flexible circuit cable 600 can be oriented such that the floating contacts 610 are positioned on one plane and the active circuit positioned on a different plane, where in this example, the two planes are 90 degrees from one another but other cable orientations are possible (e.g., 45 degrees). Also shown in the cable 600 are alignment holes 630 that can be utilized to align the floating contacts 610 with signal leads from external circuit boards.

FIG. 7 shows an example of a flexible circuit cable 700 that is integrated with a front housing 710 and a rear housing 720. This configuration depicted in FIG. 7 can be employed to receive an optical cable that transmits and receives light signals for example. As shown, a pressure pad 730 can be employed to apply contact pressure to a plurality of floating contacts. The pressure pad 730 can also be attached to the front housing 710. The pressure pad 730 can be utilized to apply a compressive force onto the top side of the contact pads, and contribute to suitable electrical contact. The pressure pad 730 can be fabricated with a material such as silicone that does not readily undergo creep, thereby maintaining its resiliency and spring-like characteristic during operation. The flexible circuit cable 700 can be fabricated with an adhesive film attached to the front surface which is used to bond the cable to the front housing 710, for example.

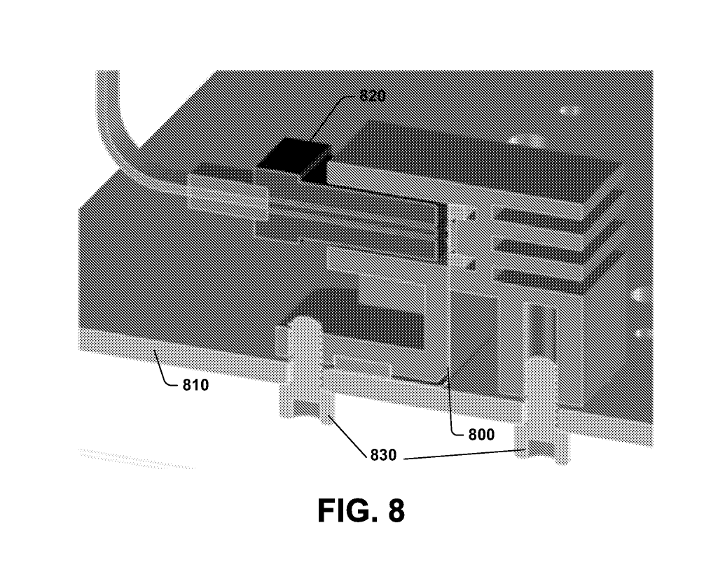

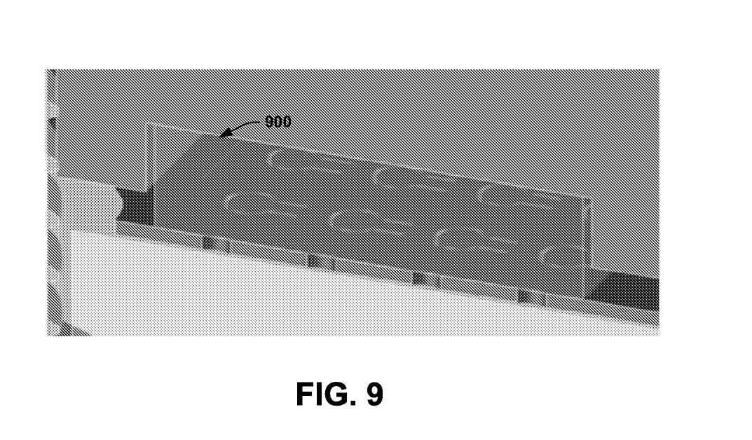

FIG. 8 illustrates an example mounting of a flexible cable and circuit 800 on to a printed circuit board 810. As shown, an optical cable 820 having light inputs and/or outputs can be coupled to the flexible cable and circuit 800. Mounting screws 830 (or other attachment component such as adhesive) can be employed to mount the flexible cable and circuit 800 to the printed circuit board 810. FIG. 9 shows a close-up view of an example pressure pad 900 applying contact pressure to a plurality of floating contacts associated with a flexible circuit cable.

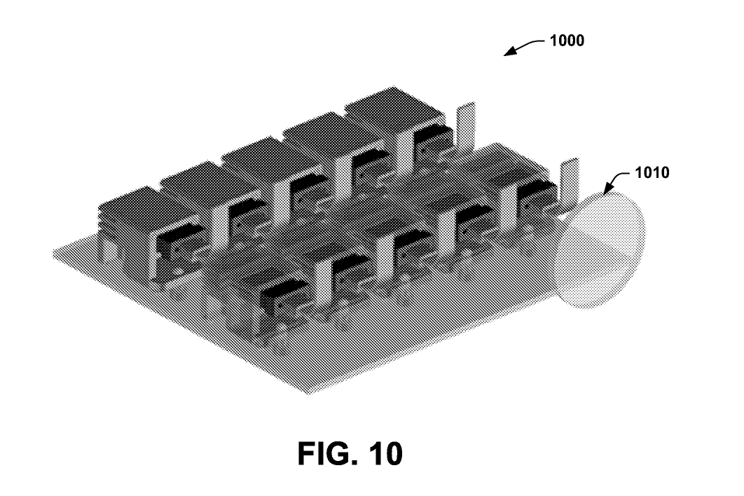

FIG. 10 shows an application example 1000 of a plurality of flexible circuit cables that are configured as an array to support multiple optical connections on a printed circuit board arrangement. To provide an idea to the scale involved for the connections, a dime-sized illustrative component is shown at 1010 to illustrate the size (e.g., about the size of a US dime) involved in making the respective connections. The components shown in the application example 1000 can be provided as part of a system that includes a flexible circuit cable to transport an electrical signal. A floating contact can be integrated into the flexible circuit cable to facilitate connection of the electrical signal between a circuit and the flexible circuit cable. In one example, an optoelectronic conversion circuit can be coupled to the flexible circuit cable to facilitate communication of the electrical signal in an optical format. The optoelectronic conversion circuit can include a laser diode to convert an electrical signal applied to the floating contact to an optical signal output in the optoelectronic conversion circuit. The optoelectronic conversion circuit can include a photodiode to convert an optical signal received at an input to the optoelectronic conversion circuit and is converted to an electrical signal at the floating contact.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. An apparatus, comprising:
a flexible circuit cable to transport an electrical signal; and
a mechanically floating contact integrated into the flexible circuit cable to facilitate connection of the electrical signal between a circuit and the flexible circuit cable.

2. The apparatus of claim 1, wherein the mechanically floating contact is coupled along a single edge across which the edge passes an electrical trace to enable flexing of the floating contact in an upward, downward, or sideways direction in relation to the flexible circuit cable.

3. The apparatus of claim 2, further comprising a pressure pad to apply contact pressure to the mechanically floating contact.

4. The apparatus of claim 3, further comprising an adhesive layer fabricated on a contact surface of the pressure pad in order to hold it in a suitable position against an array of floating contacts.

5. The apparatus of claim 4, further comprising a component to apply a compressive force through the pressure pad and across the array of floating contacts, wherein the component includes a screw or cantilever latch.

6. The apparatus of claim 2, wherein the mechanically floating contact wipes an associated contact pad when the mechanically floating contact is flexed.

7. The apparatus of claim 1, further comprising an alignment post formed into a structure that frames or surrounds an array of floating contacts, wherein the alignment post can serve to align the array of floating contacts with respect to electrical contacts formed on a second structure having a mating array of electrical contacts.

8. The apparatus of claim 1, further comprising an active circuit that is integrated on to the flexible cable and connected to the mechanically floating contact.

9. The apparatus of claim 8, wherein the active circuit is associated with an optoelectronic conversion circuit that is connected to the mechanically floating contact.

10. The apparatus of claim 9, wherein the optoelectronic conversion circuit includes a laser diode to convert an electrical signal applied to the mechanically floating contact to an optical signal output in the optoelectronic conversion circuit.

11. The apparatus of claim 9, wherein the optoelectronic conversion circuit includes a photodiode to convert an optical signal received at an input to the optoelectronic conversion circuit and is converted to an electrical signal and routed to an external circuit thru the mechanically floating contact.

12. The apparatus of claim 9, wherein the optoelectronic conversion circuit is configured as an array of optoelectronic conversion circuits on a printed circuit board.

13. A system, comprising:
a flexible circuit cable to transport electrical signals;
an array of mechanically floating contacts integrated into the flexible circuit cable to facilitate connection of the electrical signals between the flexible circuit cable and a secondary array of electrical contacts on a second circuit board; and
an optoelectronic conversion circuit coupled to the flexible circuit cable to facilitate communication of the electrical signals in an optical format.

14. The system of claim 13, wherein the optoelectronic conversion circuit includes a laser diode to convert an electrical signal applied to the mechanically floating contacts to an optical signal output in the optoelectronic conversion circuit.

15. The system of claim 13, wherein the optoelectronic conversion circuit includes a photodiode to convert an optical signal received at an input to the optoelectronic conversion circuit and is converted to an electrical signal and routed to an external circuit at the mechanically floating contacts.
